(19) United States
(12) Patent Application Publication
(10) Pub. No.: US 2023/0280832 A1
(43) Pub. Date: Sep. 7, 2023

(54) SIGNAL GENERATION DEVICE, SIGNAL GENERATION METHOD, AND SIGNAL GENERATION PROGRAM

(71) Applicant: Murata Manufacturing Co., Ltd., Nagaokakyo-shi (JP)

(72) Inventor: Masaru MATSUURA, Nagaokakyo-shi (JP)

(21) Appl. No.: 18/296,651

(22) Filed: Apr. 6, 2023

Related U.S. Application Data
(63) Continuation of application No. PCT/JP2021/035790, filed on Sep. 29, 2021.

(30) Foreign Application Priority Data
Oct. 7, 2020 (JP) 2020-169709

(51) Int. Cl. G06F 3/01; A63F 13/285; A63F 13/24

(52) U.S. Cl. CPC G06F 3/016; A63F 13/285; A63F 13/24

(57) ABSTRACT

A tactile sense is provided that gives an impression closer to a psychological impression intended to be given by the tactile sense. In an aspect, a signal generation device acquires external parameters including parameters indicative of sensory characteristics, and generates a waveform signal based on the external parameters to cause an object to vibrate.

### CROSS REFERENCE TO RELATED APPLICATIONS

This application is a continuation of PCT Application No. PCT/JP2021/035790, filed Sep. 29, 2021, which claims priority to Japanese Patent Application No. 2020-169709, filed Oct. 7, 2020, the entire contents of each of which are hereby incorporated by reference in their entirety.

### TECHNICAL FIELD

The present invention relates to a signal generation device, a signal generation method, and a signal generation program.

### BACKGROUND

There currently exists known devices to present a tactile sense by generating vibration. For example, Japanese Unexamined Patent Application Publication No. 2006-058973 (hereinafter “Patent Document 1”) discloses a technique to create and store tactile information for reproducing a tactile sense to be given to an operating body, and to give a user's finger the tactile sense using the tactile information at the time of user's input operation. Moreover, Japanese Unexamined Patent Application Publication No. 2019-060835 (hereinafter “Patent Document 2”) discloses a technique related to a device for presenting the amount of sense by controlling a vibration waveform pattern or the frequency of vibration.

In the conventional technology, it is difficult to put an actual impression of a tactile sense presented to a user by vibration closer to a psychological impression intended to be given to the user by the tactile sense.

### SUMMARY OF THE INVENTION

Accordingly, it is an object of the present invention to provide technology related to presenting a tactile sense that gives an impression closer to a psychological impression intended to be given by the tactile sense.

In an exemplary aspect, a signal generation device is provided that includes an acquisition unit configured to acquire external parameters including parameters indicative of sensory characteristics; and a generation unit configured to generate a waveform signal based on the external parameters to cause a target object to vibrate.

In another exemplary aspect, a signal generation method is provided that includes acquiring external parameters including parameters indicative of sensory characteristics; and generating a waveform signal based on the external parameters to cause a target object to vibrate.

In yet another exemplary aspect, a signal generation program is provided that causes a computer to acquire external parameters including parameters indicative of sensory characteristics; and generate a waveform signal based on the external parameters to cause a target object to vibrate.

According to the exemplary aspects of the present invention, technology is provided that is related to presenting a tactile sense that gives an impression closer to a psychological impression intended to be given by the tactile sense.

### BRIEF DESCRIPTION OF DRAWINGS

FIG. 1 is a diagram illustrating an overview of a game system according to an exemplary embodiment.

FIG. 2 is a diagram illustrating the hardware configuration of the game system according to the exemplary embodiment.

FIG. 3 is a block diagram illustrating a signal generation device according to the exemplary embodiment.

FIG. 4 is a table for describing external parameters according to the exemplary embodiment.

FIG. 5 is a diagram for describing an example of transformation processing to internal parameters according to the exemplary embodiment.

FIG. 6 is a diagram for describing an example of the transformation processing to the internal parameters according to the exemplary embodiment.

FIG. 7 is a diagram for describing an example of waveform signal generation processing according to the exemplary embodiment.

FIG. 8 is a diagram for describing a processing flow by the signal generation device according to the exemplary embodiment.

FIG. 9 is a diagram illustrating an overview of a system according to a modification of the exemplary embodiment.

FIG. 10 is a diagram illustrating an overview of a system according to another modification of the exemplary embodiment.

FIG. 11 is a diagram illustrating an overview of a system according to still another modification of the exemplary embodiment.

### DETAILED DESCRIPTION OF EMBODIMENTS

An exemplary embodiment of the present invention will be described in detail below with reference to the accompanying drawings. Note that the same elements are given the same reference numerals to omit redundant description as much as possible.

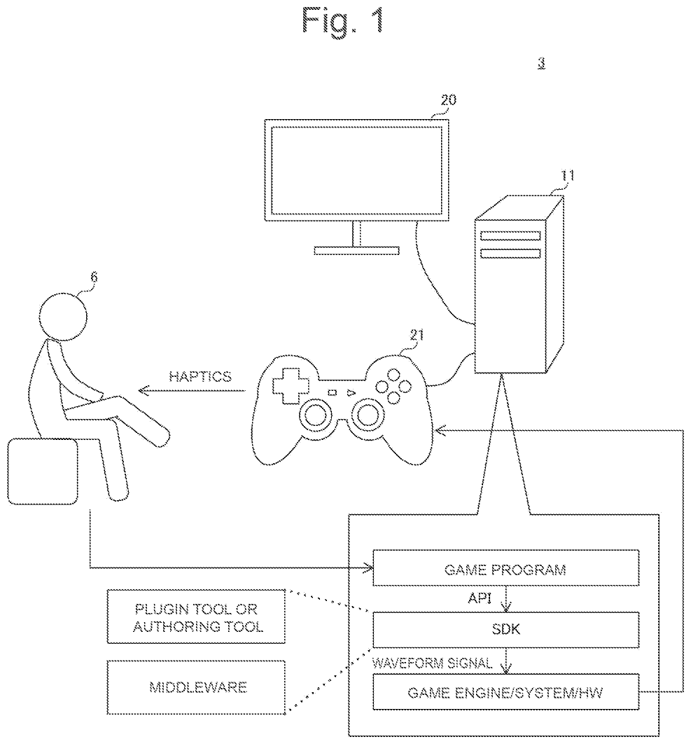

A game system according to the exemplary embodiment will be described. FIG. 1 is a diagram illustrating an overview of the game system according to the present embodiment. As illustrated in FIG. 1, a game system 3 mainly includes a computer 11, a display monitor 20, and a controller 21, which can be considered a “target object” according to the present disclosure.

In operation, the computer 11 executes a game program and displays, on the display monitor 20, a virtual reality deployed by the game program. A user 6 is, for example, a game program creator or a game player. For example, the user 6 recognizes the situation of a character in the virtual reality projected on the display monitor 20, and operates the controller 21 to give movement to the character according to the situation. The computer 11 executes the game program according to the details of the operation performed on the controller 21.

Further, the computer 11 presents, to the user 6, at least one of “force sense,” “pressure sense,” and “tactile sense” by haptics, which can also be considered “haptic presentation”. Here, for example, the “force sense” includes a feel when being pulled or pushed, and a sense of response when being tightly held down or popped up. The “pressure sense” is, for example, a sense of touch when touching an object or when feeling the hardness or softness of the object. The “tactile sense” is, for example, a feeling of touch on the surface of the object, or a tactile sense and a feeling of roughness such as an uneven degree of the surface of the object.

The hierarchy of software and hardware in the computer 11 is composed of a game program in an application layer, an SDK (Software Development Kit) in a middle layer, and system/game engine/HW (Hardware) in a physical layer.

The SDK includes, for example, plugins or an authoring tool and middleware. In the middleware, a program for vibrating the controller 21 to give the user 6 at least one of the “force sense,” the “pressure sense,” and the “tactile sense”, which may also be called a “target program” is included. For example, when a specific event has occurred to a character, the game program calls the target program according to an API (Application Programming Interface). At this time, for example, the game program passes, to the target program, event information indicative of the type of event and the start time of the event. The type of event is identified, for example, by an ID.

The specific event is, for example, that an external force to pull or push the character is applied to the character in the virtual reality, that the character shot a gun, that the character was hit, that the character is dancing to the music, or the like.

Based on the event information, the target program generates a waveform signal for haptic presentation of a sense according to the type of event indicated by the event information. The target program transmits the generated waveform signal to the controller 21 through the game engine, an operating system, and hardware.

In response, the controller 21 vibrates based on the waveform signal. The user 6 can hold the vibrating controller 21 by hand to recognize the situation of the character in the virtual reality by at least one of the “force sense,” the “pressure sense,” and the “tactile sense” in addition to sight and hearing.

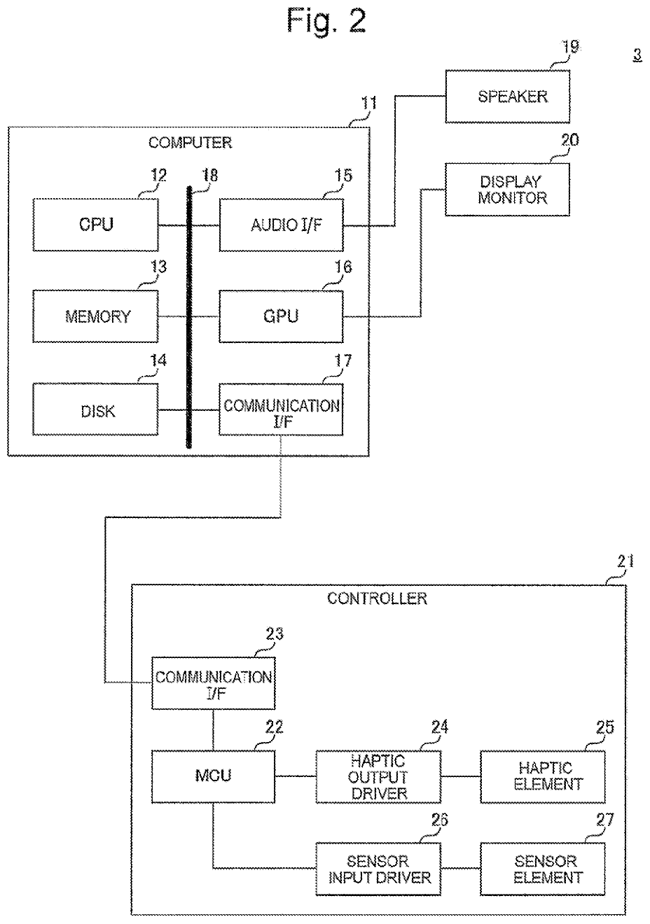

FIG. 2 is a diagram illustrating the hardware configuration of the game system according to the present embodiment. As illustrated in FIG. 2, the game system 3 includes the computer 11, a speaker 19, the display monitor 20, and the controller 21. The computer 11 includes a CPU (Central Processing Unit) 12, a memory 13, a disk 14, an audio interface (I/F) 15, a GPU (Graphics Processing Unit) 16, a communication interface (I/F) 17, and a bus 18. The controller 21 includes an MCU (Micro Controller Unit) 22, a communication interface (I/F) 23, a haptic output driver 24, a haptic element 25, a sensor input driver 26, and a sensor element 27.

In the computer 11, the CPU 12, the memory 13, the disk 14, the audio interface 15, the GPU 16, and the communication interface 17 are connected to one another through the bus 18 to be able to transmit and receive data to and from one another.

In the present embodiment, the disk 14 is a non-volatile storage device capable of reading and writing data such as an HDD (Hard Disk Drive) or an SSD (Solid State Drive), on which programs (code) such as the game program and the SDK are stored. Note that the disk 14 is not limited to the HDD or the SSD, and it may also be a memory card, a read-only CD-ROM (Compact Disc Read Only Memory), a DVD-ROM (Digital Versatile Disc-Read Only Memory), or the like. Further, the programs such as the target program can be installed externally. Further, the programs such as the target program circulate in such a state as to be stored on a storage medium readable by the computer 11 like the disk 14. Note that the programs such as the target program may also circulate on the Internet connected through the communication interface.

Moreover, in an exemplary aspect, the memory 13 is a volatile storage device such as a DRAM (Dynamic Random Access Memory). The communication interface 17 transmits and receives various data to and from the communication interface 23 in the controller 21. This communication may be performed by wire or wirelessly, and any communication protocol may be used as long as the communication with each other can be performed. The communication interface 17 transmits various data to the controller 21 according to instructions from the CPU 12. Further, the communication interface 17 receives various data transmitted from the controller 21, and outputs the received data to the CPU 12.

Upon execution of a program, the CPU 12 transfers, to the memory 13, the program stored on the disk 14 and data required to execute the program. The CPU 12 reads, from the memory 13, processing instructions and data required to execute the program, and executes arithmetic processing according to the content of the processing instructions. At this time, the CPU 12 may newly generate data required to execute the program and store the data in the memory 13. It is noted that the CPU 12 is not limited to acquiring the program and data from the disk 14, and the CPU 12 may also acquire the program and data from a server or the like via the Internet.

Specifically, for example, upon execution of the game program, the CPU 12 receives the details of operations of the user 6 to the controller 21 to execute processing instructions according to the operation details in order to give movement to the character in the virtual reality. At this time, the CPU 12 performs processing for haptic presentation, video display, and audio output according to the situation of the character in the virtual reality.

More specifically, for example, when the external force to pull or push the character is applied to the character in the virtual reality, the CPU 12 generates a waveform signal for haptic presentation of the force sense when the external force is applied.

Further, for example, when the character shoots a gun in the virtual reality, the CPU 12 generates a waveform signal for haptic presentation of a sense of reaction when the character shot the gun.

Further, for example, when the character was hit in the virtual reality, the CPU 12 generates a waveform signal for haptic presentation of a sense of shock when the character was hit.

Further, for example, when the character is dancing to the music in the virtual reality, the CPU 12 generates a waveform signal for haptic presentation of a feeling of dynamism toward musical beat and rhythm.

The CPU 12 digitally encodes the generated waveform signal to generate haptic information, and outputs the generated haptic information to the controller 21 via the communication interface 17.

Further, the CPU 12 is configured to generate screen information required for video display such as the character moving in the virtual reality and the background, and outputs the generated screen information to the GPU 16. For example, the GPU 16 receives the screen information from the CPU 12, performs rendering and the like based on the screen information, and generates a digital video signal including a video such as 3D graphics. The GPU 16 transmits the generated digital video signal to the display monitor 20 to display the 3D graphics and the like on the display monitor 20.

Further, the CPU 12 is configured to generate audio information indicative of audio according to the environment, movement, and situation of the character in the virtual reality, and outputs the generated audio information to the audio interface 15. For example, the audio interface 15 receives the audio information from the CPU 12, performs rendering and the like based on the received audio information, and generates an audio signal. The audio interface 15 transmits the generated audio signal to the speaker 19 to output sound from the speaker 19.

The haptic element 25 in the controller 21 is a vibration actuator to convert an electronic signal to mechanical vibration, which is, for example, a voice coil actuator with a wide frequency band of vibration dampening. Note that the haptic element 25 may also be an eccentric motor, a linear resonant actuator, an electromagnetic actuator, a piezoelectric actuator, an ultrasonic actuator, an electrostatic actuator, a polymer actuator, or the like, according to various exemplary aspects.

The MCU 22 is configured to control the haptic output driver 24 and the sensor input driver 26. Specifically, for example, when power is supplied, the MCU 22 reads a program stored in a ROM (not illustrated) to execute arithmetic processing according to the content of the program.

In the present embodiment, for example, when receiving the haptic information from the computer 11 via the communication interface 23, the MCU 22 controls the haptic output driver 24 based on the received haptic information to perform haptic presentation by the haptic element 25.

Specifically, the MCU 22 outputs the haptic information to the haptic output driver 24. The haptic output driver 24 receives the haptic information from the MCU 22, generates an analog electronic signal as an electronic signal according to the waveform signal and capable of driving the haptic element 25 based on the received haptic information, and outputs the electronic signal to the haptic element 25. Thus, the haptic element 25 vibrates based on the electronic signal to perform a haptic presentation.

In an exemplary aspect, the sensor element 27 is configured to senses the movements of operation parts operated by the user 6 such as a joystick and a button provided in the controller 21, and outputs an analog electronic signal indicative of the sensing results to the sensor input driver 26.

For example, the sensor input driver 26 operates under the control of the MCU 22 to supply, to the sensor element 27, power required to drive, and receives an electronic signal from the sensor element 27 to convert the received electronic signal to a digital signal. The sensor input driver 26 outputs the converted digital signal to the MCU 22. Based on the digital signal received from the sensor input driver 26, the MCU 22 generates operation information indicative of the details of operations of the user 6 to the controller 21, and transmits the operation information to the computer 11 via the communication interface 23.

[Configuration of Signal Generation Device]

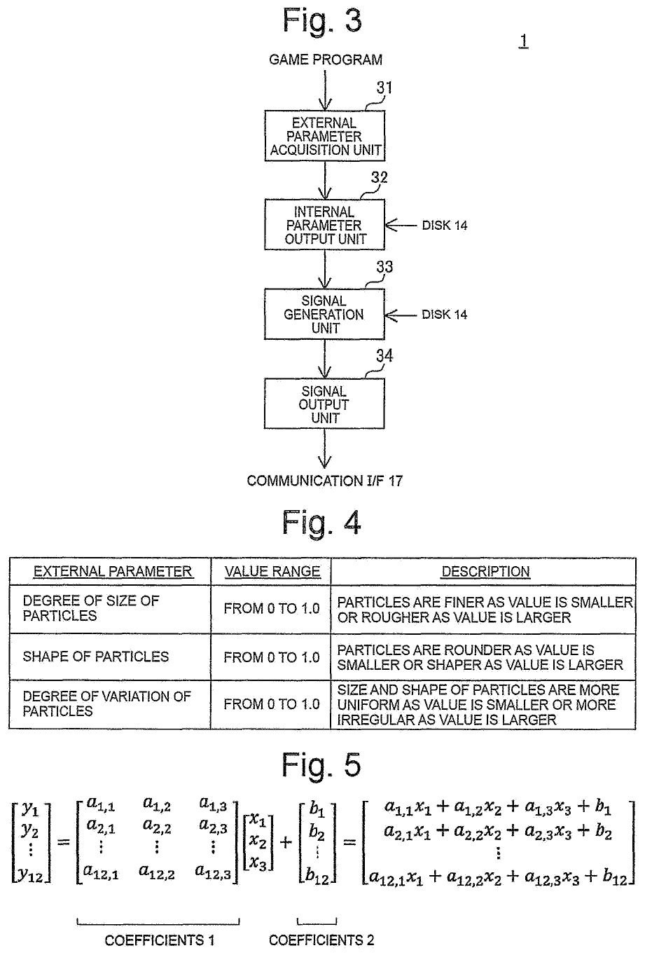

FIG. 3 is a block diagram illustrating the configuration of a signal generation device according to the present embodiment. For example, a signal generation device 1 is implemented by causing the CPU 12 in the computer 11 to execute a signal generation program as an example of the target program. The signal generation device 1 includes, as functional blocks, an external parameter acquisition unit 31, an internal parameter output unit 32, a signal generation unit 33, and a signal output unit 34.

When a specific event has occurred to the character in the virtual reality, the external parameter acquisition unit 31 causes the controller 21 (e.g., the haptic element 25) to vibrate, and acquires, from the game program, external parameters to perform a predetermined haptic presentation.

The external parameters include parameters indicative of sensory (or psychological) characteristics perceived by the user (holding the controller 21, for example) by the haptic presentation. For example, the sensory characteristics include a material texture perceived by the user by the haptic presentation. For example, when the material texture is a texture of a material composed of particles, the external parameters include parameters indicating what properties the particles have. In other words, the external parameters include parameters related to virtual particles in the tactile sense presented by the vibration to the user of the controller 21 (e.g., a target object).

An example of external parameters indicative of the material texture properties of particles in the haptic presentation (for example, the tactile sense) as sensory characteristics are illustrated in FIG. 4. As illustrated in FIG. 4, the external parameters include, as parameters indicative of the material texture properties, a parameter to specify the “degree of particle size,” a parameter to specify the “particle shape,” and a parameter to specify the “degree of particle variation.” A value in a range of 0 to 1.0 is set to each of these external parameters. The parameter to specify the “degree of particle size” indicates that the particles are finer as the value is smaller or that the particles are rougher as the value is larger. The parameter to specify the “particle shape” indicates that the particle shape is rounder as the value is smaller or that the particle shape is shaper as the value is larger. The parameter to specify the “degree of particle variation” indicates that the particle size and shape are more uniform as the value is smaller or that the particle size and shape are more irregular as the value is larger.

For example, when the “degree of particle size” is set to 0.1, the “particle shape” is set to 0.8, and the “degree of particle variation” is set to 0.4 as the external parameters, a rough haptic presentation is performed through the controller 21. Further, for example, when the “degree of particle size” is set to 0.8, the “particle shape” is set to 0.5, and the “degree of particle variation” is set to 0.7 as the external parameters, a rugged haptic presentation is performed.

In the example of FIG. 4, the external parameters acquired by the external parameter acquisition unit 31 include three parameters with a value of 0 to 1.0 set therefor, respectively. Many types of haptic presentations can be performed by a combination of three external parameters changeable in multiple stages. As a result, since a more appropriate type of haptic presentation can be selected from choices more than ever before, a sense of presence can be improved. Similarly, it becomes easier to express the tactile sense conventionally difficult to express, increasing available scenes.

It should be appreciated that the external parameters indicative of the sensory characteristics illustrated in FIG. 4 are just an example, and the external parameters may also include other parameters, or may not include any one or all of the above three parameters. For example, the external parameters may also include parameters indicative of physical properties of vibration, i.e., different from the sensory characteristics.

After the external parameter acquisition unit 31 acquires the external parameters, signal generation is performed by the signal generation unit 33 to be described later during a predetermined period of the haptic presentation of the same characteristics or until the next external parameters are acquired. As a modification, haptic presentations of different characteristics may be performed over time. In this case, for example, the external parameter acquisition unit 31 acquires a set of external parameters and a parameter indicative of the execution start timing of each haptic presentation according to the external parameters. When the external parameter acquisition unit 31 acquires two or more sets of parameters, the characteristics in the haptic presentation may also be complemented by the internal parameter output unit 32 or the signal generation unit 33 to be described later to make a change in characteristics of the haptic presentation smooth between execution start timings.

In an exemplary aspect, the external parameters are stored in the game program for a game content in the game system 3 illustrated in FIG. 1. Alternatively, upon development of the game content, a waveform signal for vibration of the controller 21 according to the specified external parameters may be generated by a processing unit having a function similar to the signal generation unit 33 to be described later, and stored in the game program. In either case, a game designer or a game developer specifies these external parameters to design a haptic presentation (for example, presentation of the tactile sense) and store the external parameters or the waveform signal in the game program. In this case, the game designer or the game developer may use GUI elements like slide bars (for example, three slide bars corresponding to the above external parameters, respectively) so that the external parameters can be specified. Alternatively, a GUI provided in the form of a palette to imitate the visual three primary colors may be used so that the external parameter can be specified.

Returning to the description of FIG. 3, based on the external parameters acquired by the external parameter acquisition unit 31, the internal parameter output unit 32 outputs internal parameters. The internal parameters are parameters indicative of the physical properties of vibration. In other words, the internal parameters are parameters indicative of physical quantities according to the generation of a waveform signal by the signal generation unit 33 to be described later. For example, the internal parameters are used as coefficients for waveform signal generation processing by the signal generation unit 33 to be described later. In other words, the internal parameter output unit 32 is a processing unit for transforming the external parameters including parameters indicative of the sensory characteristics into parameters indicative of the physical quantities according to the generation of a waveform signal. Information (e.g., coefficients) used for the transformation processing may be acquired from the disk 14.

Processing for outputting the internal parameters from the external parameters by the internal parameter output unit 32 (hereinafter also called “transformation processing”) is executed by using arbitrary processing. As the transformation processing by the internal parameter output unit 32, for example, an affine transformation prescribed to output the internal parameters from the external parameters may also be used. The coefficients required in the transformation processing may be determined by a statistical method or machine learning. For example, the coefficients may be determined based on the relationships between the external parameters and the internal parameters derived by the statistical method or machine learning.

Referring to FIG. 5, an example of a method of using the affine transformation in the transformation processing will be described. FIG. 5 illustrates an example of a formula to transform external parameters (x1, x2, x3) into internal parameters (y1, y2, y3, y4, y5, y6, y7, y8, y9, y10, y11, y12) by the affine transformation. In this example, coefficients 1 and coefficients 2 are used as the coefficients. Further, in this example, the number (12) of internal parameters is larger than the number (3) of external parameters. Thus, by outputting the internal parameters larger in number than the external parameters, a more variety of waveform signals can be generated by processing of the signal generation unit 33 to be described later (that is, a more variety of haptic presentations can be performed).

Note that the number of internal parameters output by the internal parameter output unit 32 may be the same as the number of input external parameters, or may be smaller than the number of external parameters. The number of internal parameters and the number of external parameters can be set arbitrarily. The same also applies to examples to be described later.

In an exemplary aspect, AI (Artificial Intelligence) such as deep learning may also be used for the transformation processing by the internal parameter output unit 32. For example, the internal parameter output unit 32 may use a neural network model (e.g., a learned model) that learned correlations between the external parameters and the internal parameters to output the internal parameters from the external parameters.

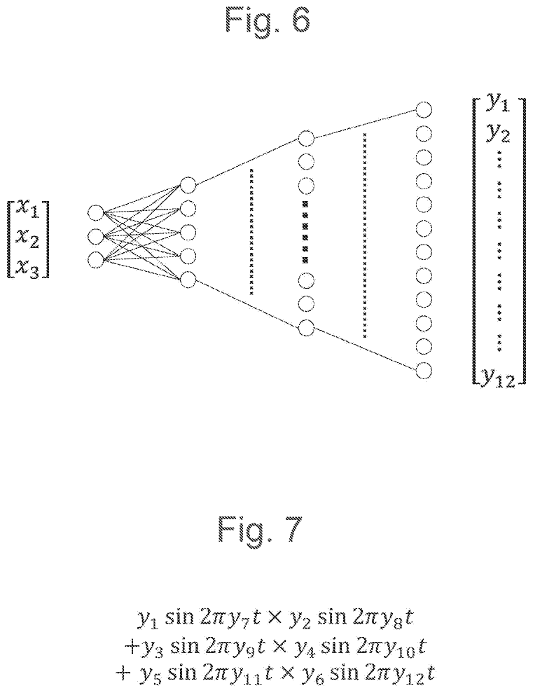

Referring to FIG. 6, an example of transformation processing using deep learning is illustrated. In the example illustrated in FIG. 6, processing for transforming the external parameters (x1, x2, x3) into the internal parameters (y1, y2, y3, y4, y5, y6, y7, y8, y9, y10, y11, y12) using the learned neural network model is conceptually illustrated.

As described above, the transformation processing by the internal parameter output unit 32 may use the statistical method, the artificial intelligence (e.g., machine learning or deep learning), or the affine transformation. Further, the transformation processing by the internal parameter output unit 32 may use a combination of at least some of the statistical method, the artificial intelligence, and the affine transformation.

Returning to the description of FIG. 3, the signal generation unit 33 is configured to generate a waveform signal for causing the target object to vibrate based on the external parameters acquired by the external parameter acquisition unit 31. More specifically, the signal generation unit 33 is configured to generate a waveform signal based on the internal parameters output by the internal parameter output unit 32 using, as input, the external parameters acquired by the external parameter acquisition unit 31. Therefore, the generated waveform signal is based on the external parameters. For example, the signal generation unit 33 performs signal processing using, as coefficients, the internal parameters output by the internal parameter output unit 32 to generate the waveform signal. Information used in the signal processing is acquired from the disk 14.

Referring to FIG. 7, an example of processing for generation of a waveform signal by the signal generation unit 33 will be described. An expression for generating a waveform signal with a sine wave is illustrated in FIG. 7. In the expression, internal parameters (for example, the internal parameters described with reference to FIG. 5 or FIG. 6) output by the internal parameter output unit 32 are set in y1 to y12. By arithmetic operation using this expression, the waveform signal is generated.

In the processing for generation of the waveform signal by the signal generation unit 33, various frequency filters or limiter processing may also be introduced. In the case of filter processing, a cutoff frequency and the like are simple internal parameters. In the case of limiter processing, limit thresholds are simple internal parameters. In either case, the internal parameters are used as physical quantity parameters according to the signal processing.

Returning to the description of FIG. 3, the signal output unit 34 digitally encodes the waveform signal generated by the signal generation unit 33 to generate haptic information and transmit the generated haptic information to the controller 21 via the communication interface 17.

As described above, the signal generation device 1 according to the present embodiment includes the external parameter acquisition unit 31 to acquire the external parameters including the parameters indicative of the sensory characteristics, and the signal generation unit 33 to generate the waveform signal to cause the object to vibrate based on the acquired external parameters.

When psychosensorily thinking about a material intended to be represented as a tactile sense, for example, the external parameters are characteristic quantities on the assumption that the material is composed of particles to represent what characteristics the psycho-sensory particles have. In other words, since the external parameters have sensory meaning, the psychological characteristics set as the external parameters match the psychological characteristics perceived by the user by the haptic presentation. This makes it easier for the game designer or the game developer to intuitively set the external parameters, improving convenience. Further, since the tactile sense of the material texture desired by the game designer or the game developer can be realized, satisfaction is improved.

Further, according to the present embodiment, the number of internal parameters output by the internal parameter output unit 32 and used by the signal generation unit 33 can be increased more than the number of external parameters acquired by the external parameter acquisition unit 31.

In general, the number of internal parameters needs to be increased in order to broaden tactile sense representations abundantly. In other words, the internal parameter output unit 32 outputs the internal parameters larger in number than the external parameters, and this makes it possible to perform a haptic presentation in more abundant tactile sense representations. In other words, according to the present embodiment, it makes it possible to perform a haptic presentation in more abundant tactile sense representations with a fewer number of external parameters. As a result, the time and effort of the game designer or the game developer are saved, improving convenience. Further, the fact that it make possible the haptic presentation in more abundant tactile sense representations with a fewer number of external parameters also leads to the reduction of the communication load by transmitting the external parameters, and the reduction of the storage capacity for the external parameters.

[Flow of Signal Generation Processing]

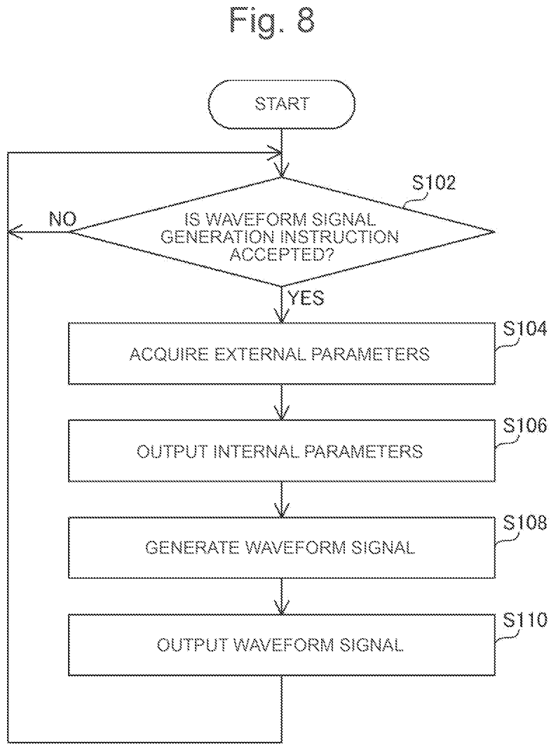

Referring to FIG. 8, an example of a processing flow for outputting a waveform signal to cause the controller 21 to vibrate by the signal generation device 1 according to an exemplary embodiment will be described. The processes already described will be described briefly here. The processing illustrated in FIG. 8 is controlled by the CPU 12.

As illustrated in FIG. 8, the signal generation device 1 first waits for acceptance of an instruction from the game program to generate a waveform signal (No in step S102). For example, when a specific event has occurred to the character in the virtual reality, the signal generation device 1 causes the controller 21 (haptic element 25) to vibrate, and accepts an instruction to perform a predetermined haptic presentation from the game program through the API (Application Programming Interface). In such a case, the signal generation device 1 is configured to determine that the instruction to generate a waveform signal is accepted (Yes in step S102). When it is determined that the instruction to generate a waveform signal is accepted, the processing proceeds to step S104.

In step S104, the signal generation device 1 acquires external parameters to perform a predetermined haptic presentation included in the instruction for generation of the waveform signal. As described above, the external parameters include parameters indicative of sensory (or psychological) characteristics perceived by the user by the haptic presentation.

Next, in step S106, the signal generation device 1 is configured to output internal parameters based on the external parameters acquired in step S104. As described above, the internal parameters are parameters indicative of the physical properties of vibration. As described above, as the processing for outputting the internal parameters based on the external parameters (e.g., transformation processing), the statistical method, the artificial intelligence (e.g., machine learning or deep learning), or the affine transformation may be used.

Next, in step S108, the signal generation device 1 generates a waveform signal to cause the object to vibrate based on the internal parameters output in step S106. For example, as described above, the signal generation device 1 uses, as coefficients, the internal parameters output in step S106 to perform signal processing in order to generate a waveform signal.

Next, in step S110, the signal generation device 1 digitally encodes the waveform signal generated in step S108 to generate haptic information and transmit the generated haptic information to the controller 21 via the communication interface 17. After that, the processing returns to step S102.

Further, although the configuration in which the signal generation device 1 of the present embodiment generates a waveform signal to cause the controller 21 to vibrate according to an event in the virtual reality is described, the present invention is not limited thereto. The configuration may also be such that, for example, when an operation target such as a construction machine, a vehicle, or an airplane is operated remotely with a controller, the signal generation device 1 generates a waveform signal to cause the controller to vibrate according to a real event to the operation target.

As described above, the signal generation device 1 according to the present embodiment acquires external parameters including parameters indicative of sensory characteristics, and generates a waveform signal to cause an object to vibrate based on the acquired external parameters. When psychosensorily thinking about a material intended to be represented as a tactile sense, for example, the external parameters are characteristic quantities on the assumption that the material is composed of particles to represent what characteristics the psycho-sensory particles have. In other words, since the external parameters have sensory meaning, the psychological characteristics set as the external parameters match the psychological characteristics perceived by the user by the haptic presentation. This makes it easier for the game designer or the game developer to intuitively set the external parameters, improving convenience. Further, since the tactile sense of the material texture desired by the game designer or the game developer can be realized, satisfaction is improved.

[Modifications]

Each exemplary embodiment described above is to make it easier to understand the present invention, and it is not intended to limit the interpretation of the present invention. The present invention can be changed/improved without departing from the scope thereof, and equivalents thereof are included in the present invention. Namely, any design change added to each embodiment by a person skilled in the art is included in the scope of the present invention as long as it has the features of the present invention. For example, each element, the arrangement, material, condition, shape, and size of the element, and the like included in each embodiment are not limited to those illustrated, and changes can be made appropriately. Further, each embodiment is just an illustrative example, and it is needless to say that configurations illustrated in different embodiments can be partially replaced or combined, and such a configuration is included in the scope of the present invention as long as it has the features of the present invention.

As modifications of the aforementioned embodiment, such systems that at least some of the computer 11, the display monitor 20, and the controller 21 included in the game system 3 are replaced with other devices, such as a tablet device, a stylus, or a head-mounted display can be configured.

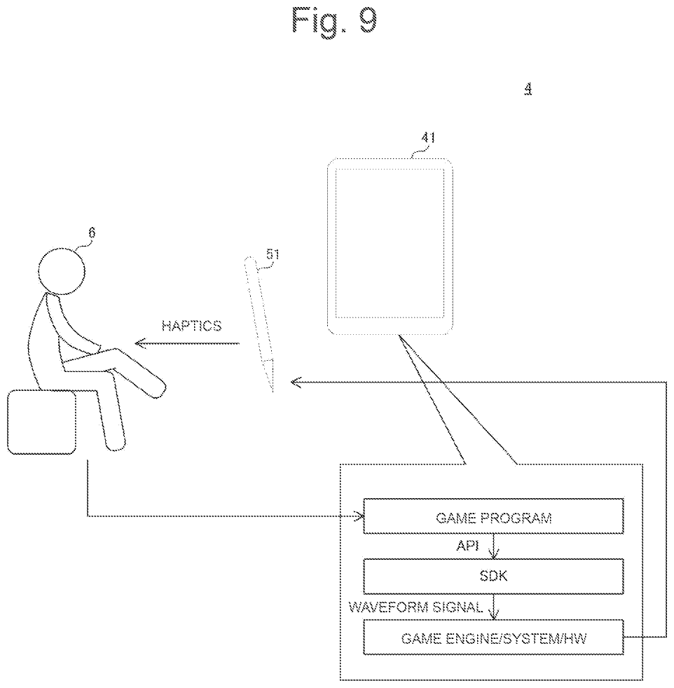

Referring to FIG. 9, a system 4 as a modification of the game system 3 according to the aforementioned embodiment will be described. The system 4 mainly includes a tablet terminal 41 and a stylus 51. The tablet terminal 41 includes a configuration similar to the computer 11 and the display monitor 20 in the game system 3. For example, the tablet terminal 41 has a plate-like enclosure, and a display unit made up of liquid crystal and the like is provided on one face thereof. The display unit is, for example, configured with a touch screen. The tablet terminal 41 is operable by moving the stylus 51 or the like while touching on the display unit. The stylus 51 presents various haptic senses to the user 6.

The stylus 51 includes a configuration similar to the controller 21 in the game system 3. The stylus 51 is a pen-like pointing device. For example, design or drawing software such as painting software, illustration software, CAD software, or 3DCG software is installed on the tablet terminal 41 so that the user 6 can perform various illustration drawings or designs by bringing the tip of the stylus 51 into contact with the display unit of the tablet terminal 41 while holding the stylus 51. For example, when the user 6 is a developer, the user 6 uses the system 4 to develop an app, while when the user 6 is a designer, the user 6 uses the system 4 for the design.

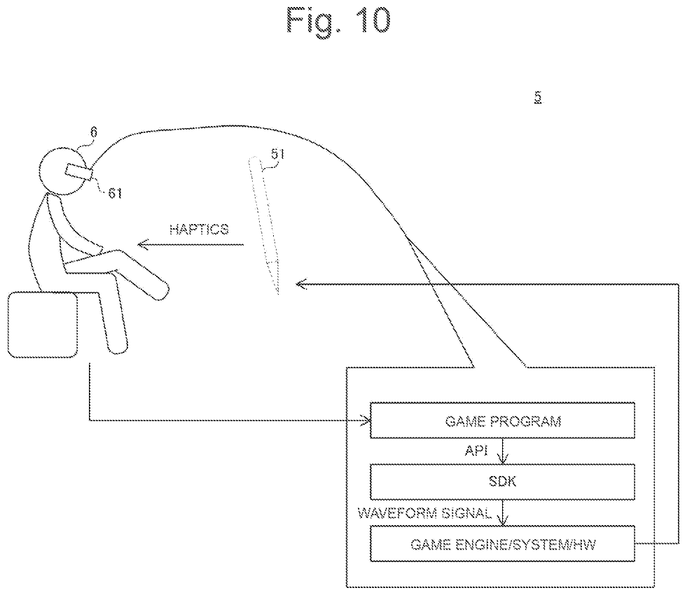

Referring next to FIG. 10, a system 5 as another modification of the game system 3 will be described. The system 5 mainly includes the stylus 51 and a head-mounted display 61. The stylus 51 and the head-mounted display 61 are configured to be communicable with each other. As described with reference to FIG. 9, the stylus 51 is a pen-like pointing device including a configuration similar to the controller 21 in the game system 3. The head-mounted display 61 includes a configuration similar to the computer 11 and the display monitor 20 in the game system 3. The head-mounted display 61 is a display device configured to be mountable on the head of the user 6.

The stylus 51 presents various haptic senses to the user 6. The user 6 can use the system 5 as a paint tool for drawing in virtual space. For example, when the user 6 is a developer, the user 6 uses the system 5 to develop an app, while when the user 6 is a designer, the user 6 uses the system 5 for the design.

The user 6 can use the system 5 as painting software or illustration software. In this case, since the stylus 51 can present various haptic senses to the user 6, the stylus 51 can change the senses to be provided to the user 6 to make the user 6 feel “on what the user 6 is drawing” an illustration or the like. For example, the stylus 51 can present, to the user 6, a smooth haptic sense as if the user 6 were drawing an illustration or the like on a paper, or a frictional haptic sense as if the user 6 were drawing the illustration or the like on a canvas.

Further, since the stylus 51 can present various haptic senses to the user 6, the stylus 51 can change the senses to be provided to the user 6 to make the user 6 feel “what the user 6 is using” to draw an illustration or the like. For example, the stylus 51 can present, to the user 6, a hard haptic sense as if the user 6 were drawing the illustration or the like with a ballpoint pen or a soft haptic sense as if the user 6 were drawing the illustration or the like with a brush.

In an exemplary aspect, the user 6 can use the system 5 as CAD software or 3DCG software. In this case, since the stylus 51 can present various haptic senses to the user 6, the stylus 51 can change the senses to be provided to the user 6 to make the user 6 feel a virtual material texture of an object being designed by the user 6. For example, the stylus 51 can present, to the user 6, a haptic sense of an object with an uneven surface. Further, the stylus 51 can present, to the user 6, a haptic sense as if the user 6 had touched a virtual object being designed or the user 6 were no longer in contact with the object.

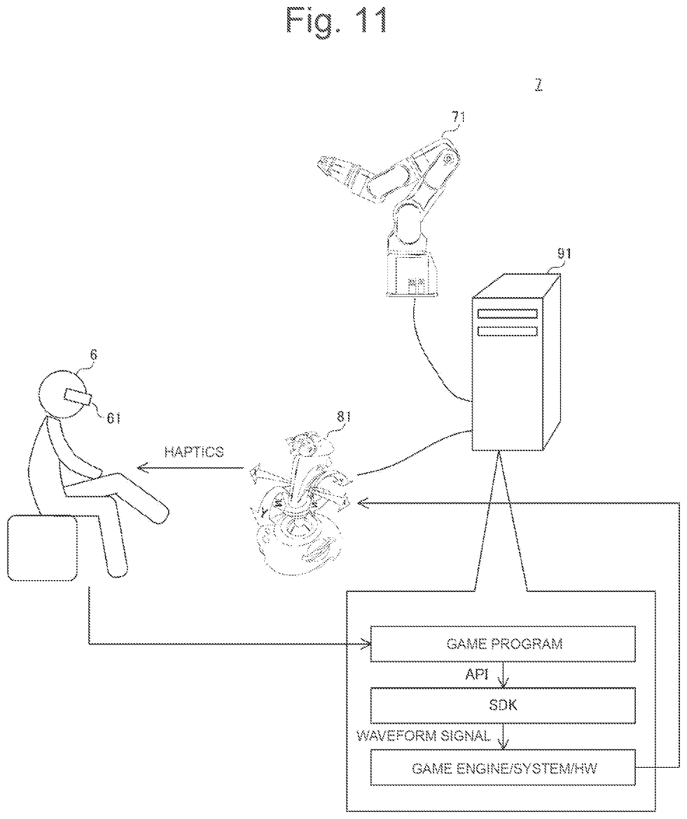

Referring next to FIG. 11, a system 7 as still another modification of the game system 3 will be described. The system 7 includes the head-mounted display 61, a computer 91, a robot 71, and a controller 81. The controller 81 includes a configuration similar to the controller 21, which is configured, for example, as a joystick type controller. In this aspect, the computer 91 includes a configuration similar to the computer 11, and is configured to be communicable with the head-mounted display 61, the robot 71, and the controller 81. For example, the computer 91 controls the operation of the robot 71 according to a control signal received from the controller 81. The robot 71 is, for example, an arm robot, but it may also be any other device such as a vehicle, a construction machine, or a drone to do certain actions. The robot 71 may exist physically in a remote area or in the neighborhood, or exist virtually.

For example, the user 6 as a developer uses the system 7 to create a program. In detail, a control signal may be transmitted from the controller 81 to the computer 91 according to an operation to the controller 81 by the user 6 as the developer to create a program for the operation of the robot 71. The created program, image information indicative of the operation of the robot 71, and the like may be transmitted from the computer 91 to the head-mounted display 61, and displayed on a display unit of the head-mounted display 61. Further, for example, the user 6 as a pilot uses the system 7 to operate the robot 71. In detail, a control signal may be transmitted from the controller 81 to the computer 91 according to an operation to the controller 81 by the user 6 as the pilot to control the operation of the robot 71.

The controller 81 can present, to the user 6, a haptic sense of a condition (for example, unevenness) of a road on which the robot 71 as a vehicle in a remote area moves. The controller 81 can present, to the user 6, a haptic sense of a situation of a location where the robot 71 as a drone flies (for example, air resistance, tailwind or headwind, and the like), or such a haptic sense that the robot 71 came into contact with something.

Further, the controller 81 can present, to the user 6, a haptic sense of a condition (for example, unevenness) of a road on which the robot 71 as a construction machine in a remote area moves, or such a haptic sense that the robot 71 came into contact with something. The controller 81 can present, to the user 6, a haptic sense of a material texture (such as an uneven sense, or soft or hard sense) of an object touched or held by the robot 71 as an end gripper (arm robot), or such a sense that the object is no longer touched.

### REFERENCE SIGNS LIST

1 . . . signal generation device
3 . . . game system
11 . . . computer
19 . . . speaker
20 . . . display monitor
21 . . . controller
31 . . . external parameter acquisition unit
32 . . . internal parameter output unit
33 . . . signal generation unit
34 . . . signal output unit

What is claimed is:

1. A signal generation device comprising:
an acquisition unit configured to acquire external parameters including parameters indicative of sensory characteristics; and
a generation unit configured to generate a waveform signal, based on the acquired external parameters, that causes an object to vibrate.

2. The signal generation device according to claim 1, wherein the external parameters include parameters related to virtual particles in a tactile sense presented by a vibration of the object to a user.

3. The signal generation device according to claim 2, wherein the external parameters include a parameter that specifies a degree of size of the virtual particles in the tactile sense.

4. The signal generation device according to claim 2, wherein the external parameters includes a parameter that specifies a shape of the virtual particles in the tactile sense.

5. The signal generation device according to claim 2, wherein the external parameters include a parameter indicative of a degree of variation in at least one of a size and a shape of the virtual particles in the tactile sense.

6. The signal generation device according to claim 2, wherein the external parameters include parameters indicative of physical properties of the vibration.

7. The signal generation device according to claim 1, further comprising an output unit configured to output internal parameters as parameters indicative of physical properties of a vibration of the object based on the external parameters.

8. The signal generation device according to claim 7, wherein the generation unit is further configured to generate a waveform signal based on the internal parameters.

9. The signal generation device according to claim 7, wherein the output includes an output of the internal parameters using a learned model obtained by learning a relationship between the external parameters and the internal parameters.

10. The signal generation device according to claim 7, wherein the output includes an output of the internal parameters using a relationship between the external parameters and the internal parameters obtained by a statistical method.

11. The signal generation device according to claim 7, wherein the output includes an output of the internal parameters using an affine transformation prescribed to calculate the internal parameters from the external parameters.

12. The signal generation device according to claim 7, wherein the output unit is further configured to output internal parameters larger in number than a number of external parameters acquired by the acquisition unit.

13. The signal generation device according to claim 1, wherein the object is a game controller.

14. The signal generation device according to claim 1, wherein the waveform signal is configured as an electronic signal that is converted by a haptic element in the object to cause the object to vibrate as a mechanical vibration.

15. The signal generation device according to claim 14, wherein the haptic element is at least one of an eccentric motor, a linear resonant actuator, an electromagnetic actuator, a piezoelectric actuator, an ultrasonic actuator, an electrostatic actuator, and a polymer actuator.

16. A signal generation method comprising:
acquiring external parameters including parameters indicative of sensory characteristics; and
generating a waveform signal based on the acquired external parameters that cause an object to vibrate.

17. The signal generation method according to claim 16, wherein the external parameters include parameters related to virtual particles in a tactile sense presented by a vibration of the object to a user.

18. The signal generation method according to claim 16, further comprising outputting, by an output unit, internal parameters as parameters indicative of physical properties of a vibration of the object based on the external parameters.

19. The signal generation method according to claim 16, further comprising providing the waveform signal as an electronic signal that is converted by a haptic element in the object to cause the object to vibrate as a mechanical vibration.

20. A signal generation program that configures a signal generation device to generate a waveform signal for causing an object to vibrate, the signal generation program that, when executed by a processor of a computer, configures the signal generation device to:
acquire external parameters including parameters indicative of sensory characteristics; and
generate a waveform signal based on the acquired external parameters that cause the object to vibrate.
